(19) United States
(12) Patent Application Publication
(10) Pub. No.: US 2015/0237685 A1
(43) Pub. Date: Aug. 20, 2015

(54) DEVICE AND METHOD FOR CHANGING AT LEAST ONE ELECTRODE OF A MELT-METALLURGICAL VESSEL

(71) Applicant: SIEMENS VAI METALS TECHNOLOGIES GMBH, Linz (AT)

(72) Inventors: Markus Dorndorf, Baden-Baden (DE); Michel Hein, Brumath (FR)

(21) Appl. No.: 14/429,717

(22) PCT Filed: Sep. 6, 2013
(86) PCT No.: PCT/EP2013/068418

§ 371 Date: Mar. 19, 2015

(30) Foreign Application Priority Data
Sep. 20, 2012 (DE) 10 2012 216 847.8

(51) Int. Cl. H05B 7/102

(52) U.S. Cl. CPC H05B 7/102

(57) ABSTRACT

A device and a method for changing at least one electrode of a melt-metallurgical vessel which has a receiving device for molten metal and a vessel cover with one opening per electrode for covering the receiving device. The at least one electrode can be positioned by means of at least one electrode support. The electrode and its support, and optionally the vessel cover can be lifted and laterally pivoted about a perpendicular rotational axis by a lifting and pivoting device. At least two electrode changing stations next to the receiving device are either adjacent to each other on a circular path about the rotational axis in a pivot range of the lifting and pivoting device or can be alternately brought onto the circular path about the rotational axis in the pivot range.

### CROSS-REFERENCE TO RELATED APPLICATIONS

The present application is a 35 U.S.C. §§371 national phase conversion of PCT/EP2013/068418, filed Sep. 6, 2013, which claims priority of German Patent Application No. 10 2012 216 847.8, filed Sep. 20, 2012, the contents of which are incorporated by reference herein. The PCT International Application was published in the German language.

### BACKGROUND OF THE INVENTION

The invention relates to a device and a method for changing at least one electrode of a melt-metallurgical vessel, which has a receiving device for molten metal and a vessel cover with one opening per electrode for covering the receiving device, wherein the at least one electrode is able to be positioned by means of at least one electrode support and the vessel cover, the at least one electrode and the at least one electrode support are also able to be lifted and laterally pivoted about a perpendicular axis of rotation by means of a lifting and pivoting device.

The rapid replacement of used electrodes is essential for an energy-efficient and time-saving smelting process in a melt-metallurgical vessel, especially an electric arc furnace, and is becoming the focus of attention with increases in performance demands made on melting plants and increases in energy prices. Electrical energy is introduced via the electrodes into the material to be melted, which is mostly in the form of metal scrap, but wherein the electrode material, which mostly consists of graphite, is consumed.

Such a device is known for example from document U.S. Pat. No. 4,345,333, wherein the melt-metallurgical plant here comprises an electric arc furnace system with a liftable and pivotable furnace cover and one to two molten metal vessels. Located next to one molten metal vessel, alternatively between the two molten metal vessels, is a cassette able to be rotated around its perpendicular central axis, having cylindrical openings for receiving used electrodes and, offset thereto, further cylindrical openings for storing new electrodes. The cassette in this case, along with its central rotating mechanism and a number of lifting cylinders disposed below the cassette and engaging into the cylindrical openings for lowering the used electrode pieces and for raising the new electrodes, is disposed entirely in the pivot area of the furnace cover.

In the direct area of influence of a melt-metallurgical vessel enormous corrosive influences act on movable mechanisms such as lifting cylinder and articulated joints, so that regular maintenance of replacement of components is unavoidable. It has been shown that the maintenance of such devices known from the prior art for exchange of electrodes must be undertaken all the more frequently when movable mechanisms are arranged in the pivot area of the furnace cover or vessel. Particles such as flaking solidified droplets of metal, dust particles etc. can fall down from the vessel cover, get into the movable mechanisms and damage or block the mechanisms.

### SUMMARY OF THE INVENTION

The object of the invention is therefore to provide a device that is as low-maintenance as possible and a method suitable for operating such a device for changing at least one electrode of a melt-metallurgical vessel.

The object is achieved for the device for changing at least one electrode of a melt-metallurgical vessel. There is a receiving device for molten metal. For covering the receiving device, there is a vessel cover with one opening per electrode, wherein the at least one electrode is able to be positioned by means of at least one respective electrode support and the vessel cover. The at least one electrode and the at least one electrode support are able to be lifted by means of a lifting and pivoting device and are also pivotable laterally by that device. At least two electrode change stations are present to cooperate with the receiving device. The stations are either disposed next to one another in a pivot area of the lifting and pivoting device on a circular track or path about the axis of rotation or are able to be brought alternately into a pivot area of the lifting and pivoting device on the circular track or path about the axis of rotation.

With such a device, no movable mechanisms demanding intensive maintenance are present in the pivot area of the vessel cover.

If the at least two electrode change stations are disposed next to one another in a pivot area of the lifting and pivoting device on a circular path about the axis of rotation, then only the electrode(s) and the electrode support move beyond this pivot area, and, optionally also the vessel cover. The electrode change stations in this case are stationary units which can be formed from simple mechanical holders. Maintenance is only required extremely rarely or not at all and can for example be carried out at the same time as required maintenance of the vessel cover.

If the electrode change stations are alternately able to be brought into the pivot area of the lifting and pivoting device on the circular track about the axis of rotation, then the mechanism for this bringing in of an electrode change station into the pivot area itself is outside the pivot area and is thus kept away from a greater stress from particles. Such an arrangement is likewise especially low-maintenance and also easily accessible for the maintenance personnel.

The vessel cover itself is preferably not moved along with the at least one electrode and the electrode support(s) during the electrode change. Optionally, the vessel cover can however also be moved as well, since any movable mechanism of the device for changing at least one electrode is located outside the pivot area.

A melt-metallurgical vessel with an inventive device hereof has been proven, wherein the device has a movable mechanism which is disposed outside the pivot area of the lifting and pivoting device and by means of which the at least two electrode change stations are able to be brought alternately into the pivot area of the lifting and pivoting device on the circular track about the axis of rotation.

The melt-metallurgical vessel preferably involves an electric arc furnace. While the electrode consumption in a conventional electric arc furnace differs in size for each electrode present because of the irregular scrap distribution and properties, the required drilling phase in which the electrodes drill into the scrap, as well as the arc lengths occurring in each case, and wherein the electrodes are in a melt-metallurgical vessel with flat bath operation, in which the arcs burn evenly on the bath surface, is very even. Thus, as a rule in flat bath operation, a simultaneous replacement of all electrodes present is to be expected.

The melt-metallurgical vessel can furthermore also involve ladle furnaces or similar melt-metallurgical vessels operated with electrodes or self-consuming energy carriers.

In such cases, it has proven useful for the at least two electrode change stations of the device to be embodied identically. Especially preferred in such cases is an embodiment or at least cladding of both electrode change stations from/with fireproof material, so that in each electrode change station, hot residual pieces of electrodes can be removed without danger. A cladding of an electrode change station with especially fireproof elastic fiber material has been proven to ameliorate the mechanical load on the residual pieces of the electrode(s) on removal and to attenuate their impact in the electrode change station.

As an alternative, a cladding can also be embodied in the form of a fireproof metallic clamping device which holds back the discharged residual pieces.

It has proved advantageous for the device for a first electrode change station of the at least two electrode change stations to comprise a storage station for residual pieces of the at least one electrode and for a second electrode change station of the at least two electrode change stations to comprise an equipping station for providing at least one replacement electrode which is able to be accepted by means of the at least one electrode support. In this way, the hot residual pieces can first of all remain in the storage station and cool down enough for it to be possible for them to be further processed without problems.

This does not result in any lost time during the equipping of the electrode support with the replacement electrodes since the replacement electrode(s) are provided by a further electrode change station.

Preferably, the first and the second electrode change stations of the device are configured to alternately form the storage station and the equipping station. Residual pieces of electrodes remaining in an electrode change station used as a storage station can be directly mechanically bound to replacement electrodes and can be used again during the next required electrode change, wherein the storage station now keeps the next replacement electrode in reserve and thus now functions as an equipping station.

In a preferred embodiment of the device, at least two, especially three, electrodes are present and are disposed on the circular track between the receiving device and an adjustment station or are disposed between the at least two electrode change stations. The adjustment station has a fireproof horizontal place for longitudinal dimension adjustment of the at least two electrodes to a uniform length dimension between the plane of the ends of the electrodes in the vessel and the at least one electrode support. Such an adjustment station is especially advantageous for a conventionally operated electric arc furnace, in which a differing level of burning off at the available electrodes occurs. But also in flat bath operation it can be necessary, even if rarely, to set the ends of the electrodes at the same height.

In a further preferred embodiment of the device, the at least two electrode change stations are connected to a vertical change unit axis of rotation which is configured to pivot the electrode change stations horizontally into the pivot area of the lifting and pivoting device and on the circular track. In such cases, the change unit axis of rotation itself is outside the pivot area and is thus protected from particles.

It has been proven that the at least two electrode change stations of the device can be assigned at least one installation unit for mechanical connection of the residual piece of the at least one electrode to at least one electrode lengthening piece. This installation unit can include a robot which automatically embodies the mechanical connection between the respective residual piece and an electrode lengthening piece, wherein residual pieces which are still hot can continue to be used. As an alternative, the installation unit includes a removal device to remove the respective residual piece from the storage station in order to manually connect that piece mechanically to an electrode lengthening piece.

The object is achieved for the method for changing at least one electrode of a melt-metallurgical vessel by means of an inventive device and with the following steps:
Lifting and pivoting the residual piece of the at least one electrode and the at least one electrode support, optionally also the vessel cover, about the axis of rotation in the direction of the at least two electrode change stations;
Positioning the residual piece of the at least one electrode and of a first electrode change station of the at least two electrode change stations in relation to one another and storing the residual piece from the at least one electrode support in the first electrode change station, which functions as a storage station;
Positioning the at least one electrode support and a second electrode change station of the at least two electrode change stations in relation to each other and equipping the at least one electrode support with at least one replacement electrode, wherein the second electrode change station functions as an equipping station;
Pivoting and lowering the at least one replacement electrode and the at least one electrode support, optionally also the vessel cover, about an axis of rotation in the direction of the receiving device;
Removing the residual piece from the storage station and/or establishing a mechanical connection between the residual piece of the at least one electrode and at least one electrode lengthening piece while forming a further replacement electrode; and
Repeating the method after a period of time Z.

During the repetition of the method, the first electrode change station can again function as a storage station and the second electrode change station can again function as an equipping station. As an alternative, however, the second electrode change station can function as a storage station and the first electrode change station as an equipping station. This is especially preferred when the residual pieces are already connected in the area of the electrode change station to electrode lengthening pieces. In each repetition of the method, the first and the second electrode change station then function alternately as storage station.

The inventive method makes possible fast, efficient and resource-saving operation of the inventive device, which because of its low maintenance requirement, minimizes interruptions in smelting operation. Residual pieces of the electrode(s) are re-used and ultimately consumed without any residues.

During storage of residual pieces and acceptance of the replacement electrode(s), it is preferred that the electrode supports are lowered or raised as necessary by means of the pivoting and lifting device.

It has proved advantageous for the first electrode change station to be pivoted about the change unit axis of rotation from a position within the pivot area of the lifting and pivoting device into a position outside the pivot area of the lifting and pivoting device and at the same time for the second electrode change station to be pivoted about the change unit axis of rotation from a position outside the pivot area of the lifting and pivoting device into a position within the pivot area of the lifting and pivoting device. As already explained above for the inventive device, in this way, the hot residual pieces can first remain in the storage station and cool off enough for their further processing to be possible without problems. A loss of time in the equipping of the electrode support with the replacement electrodes does not occur as a result, since the replacement electrode(s) are provided by a further electrode change station. The arrangement of the change unit axis of rotation outside the pivot area of the lifting and pivoting device or of the vessel cover has a favorable, i.e. lengthening, effect on the maintenance cycles of the electrode change stations.

With uneven consumption of a number of available electrodes, there is preferably a lifting and pivoting of the unevenly long residual pieces of the electrodes and of the at least one electrode support about the axis of rotation in the direction of the adjustment station disposed between the receiving device and the at least two electrode change stations, wherein the at least one electrode support is shifted in relation to the held electrode such that the residual pieces are leveled on the horizontal plane of the adjustment station with their ends facing away from the at least one electrode support and wherein a subsequent pivoting and lowering of the leveled electrodes and of the at least one electrode support about the axis of rotation in the direction of the receiving device is undertaken. The plane therefore serves to set the free ends of the electrodes which protrude during operation through the vessel cover into the receiving device to an equal height or to level them in order to maintain even smelting operation.

### BRIEF DESCRIPTION OF THE DRAWINGS

FIGS. 1 to 5 explain inventive devices on melt-metallurgical vessels and methods for their operation by way of examples. In the figures:

FIGS. 1 to 3 are views from above which show schematics of an electric arc furnace with a first device;

FIG. 4 shows a partial section through the electric arc furnace; and

FIG. 5 is a view from above which shows a schematic of an electric arc furnace with a second device.

### DESCRIPTION OF EMBODIMENTS

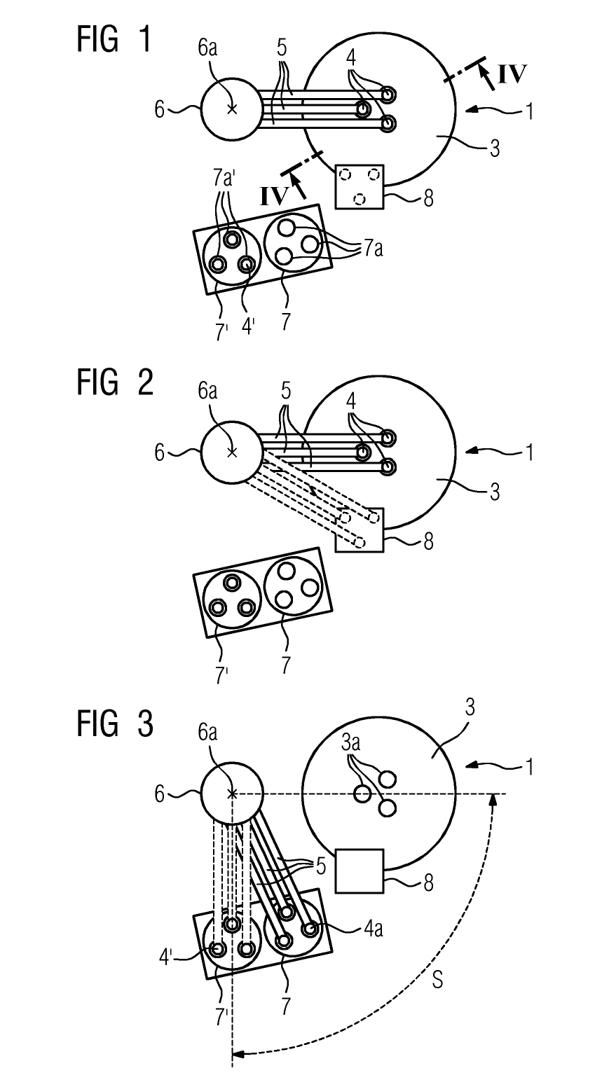

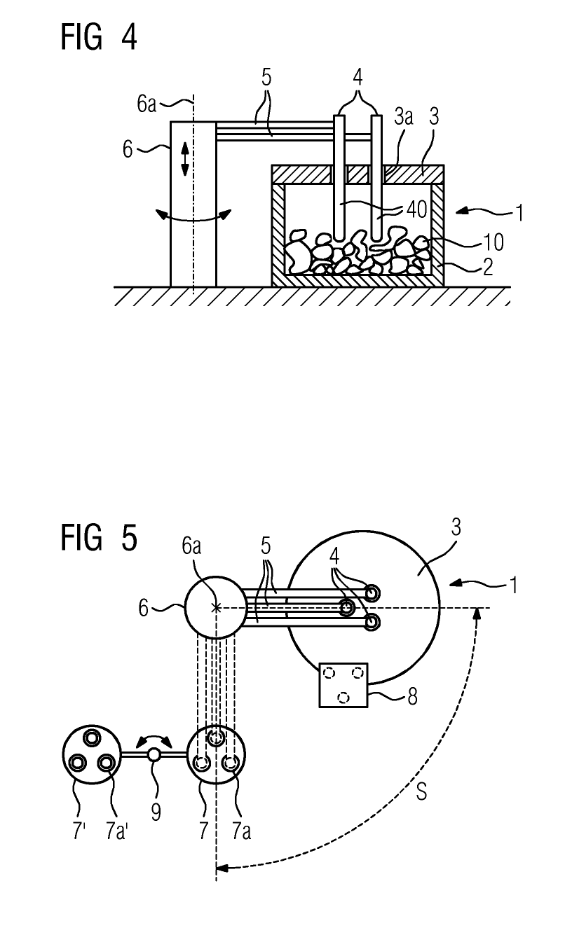

FIGS. 1 to 3 are schematic views from above of a melt-metallurgical vessel 1 in the form of an electric arc furnace with a first device for changing the electrodes 4. The melt-metallurgical vessel 1 comprises a receiving device 2 for molten metal (see also FIG. 4, which shows a part section IV-IV through the electric arc furnace). For covering the receiving device 2, a vessel cover 3 is provided having a respective opening 3a per electrode 4 in each case. Scrap metal 10 to be melted is located in the receiving device 2.

Each electrode 4 is configured to be positioned by means of a respective electrode support 5. By means of a lifting and pivoting device 6, each electrode 4 and its electrode support 5, and optionally also the vessel cover 3, are configured to be lifted and pivoted laterally about a perpendicular axis of rotation 6a.

Spaced away from the receiving device 2, there are two electrode change stations 7, 7′, which are disposed next to one another in a pivot area S (cf. FIG. 3) of the lifting and pivoting device 6 and on a circular track or path about the axis of rotation 6a. Each electrode change station 7, 7′ has three openings 7a which can accommodate replacement electrodes or residual pieces of electrodes 4.

If the electrodes 4 are too short during operation of the electric arc furnace, then the residual pieces of the electrodes 4 are lifted by their respective electrode holders 5 via the lifting and pivoting device 6 and are pivoted in the direction of the electrode change stations 7, 7′. The residual pieces 4a of the electrodes 4 are positioned at the first electrode change station 7, which functions as a storage station, and the electrode holders 5 are lowered and released. This guides the still heated residual pieces 4a of the electrodes 4 into the respective openings 7a of the first electrode change station 7. The electrode holders 5 are lifted and further pivoted in the direction of the second electrode change station 7′, which functions here as equipping station.

In the openings 7a′ of the change station, replacement electrodes 4′ are located. These are fixed in the electrode holders 5. The electrode holders 5 including the replacement electrodes 4′ are raised and pivoted back to the vessel cover 3. After subsequent lowering of the replacement electrodes 4′ through the openings 3a in the vessel cover 3 the melt-metallurgical process can be continued. The shortened residual pieces 4a are installed on electrode lengthening pieces, so that further replacement electrodes are produced. This can be done in the area of the first change station 7 or else at another location after removal of the cooled residual pieces 4a from the first change station. These further replacement electrodes can now for example be stored in the first electrode change station 7, which consequently functions as an equipping station. But also a renewed use of the second electrode change station 7′ as equipping station is possible.

If the replacement electrodes 4′ are also burnt away, in the area of the first or second electrode change station 7, 7′ the residual pieces are stored and the replacement electrodes are accepted into the area of the respective other electrode change station 7, 7′.

The two electrode change stations 7, 7′, in the first device shown in FIGS. 1 to 3 are installed at six locations and have no moving parts, so that no intensive maintenance activities are necessary.

Optionally located in the pivot area S between the receiving device 2 and the electrode change stations 7, 7′ is an adjustment station 8. In flat bath operation such an adjustment station 8 can mostly be dispensed with. If the electrodes 4 burn away unevenly quickly and one or two electrodes 4 become shortened more than the remaining electrodes, the free ends 40 of the electrodes 4 can be brought to an equal level by means of the adjustment station 8. To do this the electrode holders 5 including the electrodes 4 are raised and pivoted over the adjustment station 8. The electrode holders 5 are lowered. Then each electrode 4 is released and set to a horizontal plane of the adjustment station 8. Now the electrode holders 5 are again connected to the electrodes 4 which are leveled in relation to one another, raised and pivoted over the vessel cover 3. After the lowering of the electrodes 4 through the openings 3a of the vessel cover 3, the melt-metallurgical process can be continued.

FIG. 5 shows a schematic view from above of a melt-metallurgical vessel 1 in the form of an electric arc furnace with a second device for changing the electrodes 4. The same reference characters as in FIGS. 1 to 4 identify the same elements. In addition to the receiving device 2, two electrode change stations 7, 7′ are present which are able to be bought alternately into the pivot area S of the lifting and pivoting device 6 on the circular track or path about the axis of rotation 6a. In this case, a change unit axis of rotation 9 is present around which the first electrode change station 7 and the second electrode change station 7′ are able to be rotated and are able to be brought alternately into the pivot area S of the lifting and pivoting device 6. Because of the arrangement of the movable mechanism of the change unit axis of rotation 9 outside the pivot area S, the second device is especially low-maintenance and easily accessible as a whole.

The arrangement of the movable electrode change stations is only shown by way of example here and can readily be implemented in another way without departing from the basic ideas of the invention.

1. A changing device for changing at least one electrode of a melt-metallurgical vessel, the changing device comprising:
a receiving device for holding molten metal;
a vessel cover with an opening for passage therethrough of a respective electrode, the cover configured for covering the receiving device;
a respective electrode support outside of the vessel supporting each of the electrodes to extend inside the vessel, wherein each electrode is positioned by the respective electrode support;
a lifting and pivoting device configured and operable for raising or lowering and for pivoting each respective at least one electrode supported by the at least one electrode support, the pivoting being laterally about a perpendicular axis of rotation around a pivot area of the lifting and pivoting device on a circular track or both about the axis of rotation;
at least two electrode change stations next to the receiving device, which are either disposed next to one another in the pivot area or are brought alternately into the pivot area of the lifting and pivoting device on the circular track or path about the axis of rotation.

2. The device as claimed in claim 1, further comprising the vessel cover is connected to be lifted by the lifting and pivoting device and is also pivoted laterally about the vertical axis of rotation.

3. The device as claimed in claim 1, wherein the at least two electrode change stations are embodied identically.

4. The device as claimed in claim 1, further comprising a first one of the at least two electrode change stations defines a storage station for a residual piece of the at least one electrode and a second one of the electrode change station comprises an equipping station configured for providing a replacement electrode to be accepted by the at least one electrode support.

5. The device as claimed in claim 4, wherein each of the electrode change stations is configured to alternately comprise the storage station and the equipping station.

6. The device as claimed in claim 1, wherein at least two of the electrodes are present;
an adjustment station is disposed on the circular track or path between the receiving device and the at least two electrode change stations, the adjustment station has a fireproof horizontal plane for equalizing the longitudinal dimensions of the at least two electrodes to a uniform longitudinal dimension between the plane and the at least one electrode support for the respective electrode.

7. The device as claimed in claim 1, further comprising a change unit connected to the at least two electrode change stations, the change unit having a second axis of rotation about which the change unit is configured to pivot the electrode change stations horizontally into the pivot area of the lifting and pivoting device and on the circular track and also out of the pivot area.

8. The device as claimed in claim 4, further comprising an installation unit for the electrode change stations, the installation unit being configured and operable for mechanical connection of the residual piece of the at least one electrode with at least one electrode lengthening piece.

9. A method for changing at least one electrode of a melt-metallurgical vessel by means of the device as claimed in claim 4, comprising the following steps:
lifting and pivoting the residual piece of the at least one electrode and also lifting and pivoting the at least one electrode support, and optionally also the vessel cover, about the axis of rotation in the directions toward the at least two electrode change stations;
positioning the residual piece of the at least one electrode and of a first electrode change station in relation to one another and storing the residual piece from the at least one electrode support in the first electrode change station, which functions as a storage station;
positioning the at least one electrode support and a second electrode change station in relation to one another and equipping the at least one electrode support with a replacement electrode, wherein the second electrode change station functions as an equipping station;
pivoting and lowering the at least one replacement electrode and the at least one electrode support, and optionally also the vessel cover, about the axis of rotation in the direction toward the receiving device and lowering them toward the receiving device;
removing the residual piece from the storage station and/or establishing a mechanical connection between the residual piece of the at least one electrode and at least one electrode lengthening piece for forming a further replacement electrode.

10. The method as claimed in claim 9, further comprising:
repeating the method after a selected period of time, during the repetition of the method, the first electrode change station and the second electrode change station function alternately as a storage station.

11. The method as claimed in claim 9, further comprising pivoting the first electrode change station about a second change unit axis of rotation from a position of the first electrode change station within the pivot area of the lifting and pivoting device into a position outside the pivot area of the lifting and pivoting device and;
at the same time, pivoting the second electrode change station about the second change unit axis of rotation from a position of the second electrode change station outside the pivot area of the lifting and pivoting device into a position within the pivot area of the lifting and pivoting device.

12. The method as claimed in claim 9, wherein when there is an uneven consumption of at least some of the electrodes, lifting and pivoting of resultant unequal-length residual pieces of the electrodes and of the at least one electrode support about the axis of rotation and in the direction of the adjustment station disposed between the receiving device and the at least two electrode change stations wherein the at least one electrode support is shifted in relation to the supported electrodes such that the residual pieces have ends facing away from the at least one electrode support wherein the ends are leveled on the horizontal plane of the adjustment station; and
subsequently pivoting and lowering the leveled electrodes and their at least one electrode support about the axis of rotation in the direction of the receiving device.

13. A melt-metallurgical vessel including a device as claimed in claim 1, the device includes a movable mechanism disposed outside the pivot area of the lifting and pivoting device for bringing the at least two electrode change stations alternately into the pivot area of the lifting and pivoting device on the circular track or path about the axis of rotation.
